(19) United States
(12) Patent Application Publication
(10) Pub. No.: US 2022/0072671 A1
(43) Pub. Date: Mar. 10, 2022

(54) Removable Dust Collection Apparatus, in Particular Removable Dust Collection Container, for a Hand-Held Power Tool

(71) Applicant: Robert Bosch GmbH, Stuttgart (DE)

(72) Inventors: Ruggero Indino, Nufringen (DE); Florian Esenwein, Leinfelden-Echterdingen (DE)

(21) Appl. No.: 17/414,282

(22) PCT Filed: Nov. 25, 2019
(86) PCT No.: PCT/EP2019/082373

§ 371 Date: Jun. 15, 2021

(30) Foreign Application Priority Data
Dec. 21, 2018 (DE) 10 2018 222 772.1

(51) Int. Cl. B23Q 11/00; B25F 5/00

(52) U.S. Cl. CPC B23Q 11/0071; B23Q 11/0046; B25F 5/00

(57) ABSTRACT

A removable dust collection apparatus, in particular a removable dust collection container, for a hand-held power tool, includes at least one basic structure, which has at least one frame for receiving a form-variable collection bag or itself delimits a collection volume at least in part. The basic structure has at least one connecting piece for connection to a blow-out connector of the hand-held power tool, the connecting piece configuring the basic structure to be removably arranged on the hand-held power tool. The dust collection apparatus further includes at least one communication unit, which is in particular wireless, for exchanging in particular electronic data with at least one external unit, in particular the hand-held power tool or a mobile communication device.

Removable dust collection apparatus, in particular removable dust collection container, for a hand-held power tool

### PRIOR ART

There are already known removable dust collection devices, in particular removable dust collection containers, for hand-held power tool, the dust collection devices comprising at least a basic structure, which has at least one frame for receiving a variable-shape collection bag or itself at least partially delimits a collection volume, wherein the basic structure has at least one connection nozzle for connection to an exhaust nozzle of the hand-held power tool, by means of which nozzles the basic structure can be arranged in a removable manner on the hand-held power tool.

### DISCLOSURE OF THE INVENTION

The invention is based on a removable dust collection device, in particular a removable dust collection container, for a hand-held power tool, comprising at least a basic structure, which has at least one frame for receiving a variable-shape collection bag or itself at least partially delimits a collection volume, wherein the basic structure has at least one connection nozzle for connection to an exhaust nozzle of the hand-held power tool, by means of which nozzles the basic structure can be arranged in a removable manner on the hand-held power tool.

It is proposed that the removable dust collection device have at least one, in particular wireless, communication unit, for exchanging in particular electronic data with at least one external unit, in particular the hand-held power tool or a mobile communication device. The communication unit of the dust collection device is preferably realized as a wireless communication unit. The communication unit of the dust collection device may be realized as a WLAN communication unit, a Bluetooth communication unit, a radio communication unit, an RF1D communication unit, an NFC unit, an infrared communication unit, a mobile network communication unit or the like. Particularly preferably, the communication unit of the dust collection device is designed for bidirectional data transmission. Alternatively or additionally, the communication unit of the dust collection device is realized as a wired communication unit such as, for example, a LAN communication unit, a USB communication unit or the like. In the case of the external unit being designed as a mobile communication device, the external unit is preferably realized as a smartphone, a tablet, a PDA or the like. Preferably, the external unit realized as a mobile communication device comprises an app for communication with the communication unit. It is also conceivable, however, for the external unit to be realized as an external storage and computing unit such as, for example, a server, a company control centre, a PC or the like.

The dust collection device is preferably realized without a drive unit, in particular an electric motor unit. Preferably, the dust collection device is realized differently from a vacuum cleaner, in particular a mobile vacuum cleaner. In particular, the dust collection device is realized as a dust bag device, a suction dome device, a dust box device or the like. The dust collection device may have a filter unit that is arranged on the basic structure, in particular in a replaceable manner. It is also conceivable, however, for the dust collection device to be realized without a filter unit, and in particular for a collection bag, for example a fabric or non-woven collection bag or the like, which can be arranged on the basic structure, in particular replaceably, to have a filter function.

If the dust collection device is of a design in which the basic structure comprises the frame for receiving a variable-shape collection bag, for example a fabric or non-woven collection bag or the like, the frame of the basic structure is preferably realized in such a manner that the collection bag, when having been arranged on the basic structure, is clamped and/or held by means of the frame. The frame is preferably arranged adjacent to the connection nozzle of the basic structure. Preferably, the frame is realized integrally with the connection nozzle. “Integrally” is to be understood to mean, in particular, connected at least in a materially bonded manner, for example by a welding process, an adhesive process, an injection process and/or another process considered appropriate by persons skilled in the art, and/or, advantageously, understood as being formed in one piece such as, for example, by being produced from a casting and/or by being produced in a single or multi-component injection process and, advantageously, from a single blank. If the dust collection device is of a design in which the basic structure itself at least partially delimits a collection volume for collecting dust, in particular dust caused by removal of material from a workpiece by means of the hand-held power tool, the basic structure preferably comprises a, in particular cylindrical or polygonal, collection container, which delimits a collection volume. The collection container is preferably arranged adjacent to the connection nozzle of the basic structure. Preferably, the collection container is realized integrally with the connection nozzle. If the dust collection device is of a design in which the basic structure itself, in particular the collection container of the basic structure, at least partially delimits a collection volume, the basic structure preferably comprises a closure element, in particular a removable lid, or a connection unit at least for releasably connecting the collection container and the connection nozzle. The basic structure may be of other designs, considered appropriate by persons skilled in the art, that are suitable for receiving a variable-shape collection bag or that themselves delimit a collection volume.

Preferably, the, in particular wireless, communication unit of the dust collection device is designed to exchange, in particular electronic, data with the at least one external unit, in particular the hand-held power tool or a mobile communication device, in order to monitor, signal or transmit a state of the dust collection device when having been arranged on the hand-held power tool, in particular on the exhaust nozzle of the hand-held power tool. In particular, it is conceivable that a distance of the dust collection device relative to the hand-held power tool is transmitted to the external unit, that a contact of the dust collection device with the hand-held power tool, in particular with the exhaust nozzle of the hand-held power tool, is evaluated and transmitted to the external unit, that characteristics are compared, in particular a vibration of the hand-held power tool is compared with a vibration of the dust collection device, or that other characteristics are sensed and/or evaluated and transmitted to the external unit. Alternatively or additionally, it is conceivable that specific data such as, for example, a serial number, a collection volume quantity, an assignment characteristic or the like of the dust collection device can be transmitted to the external unit by means of the, in particular wireless, communication unit of the dust collection device. Preferably, an open-loop control or closed-loop control of the hand-held power tool is dependent on an exchange of, in particular electronic, data between the, in particular wireless, communication unit of the dust collection device and the external unit. “Designed” is to be understood to mean, in particular, specially programmed, configured and/or equipped. That an element and/or a unit are/is designed for a particular function, is to be understood to mean, in particular, that the element and/or the unit fulfill/fulfils and/or executes this particular function in at least one application state and/or operating state.

The design according to the invention advantageously enables data useful for safe operation of the hand-held power tool to be transmitted between the dust collection device and the external unit. In particular, transmission of data advantageously makes it possible to monitor correct arrangement of the dust collection device on the hand-held power tool. It is advantageously possible to achieve a high level of safety, in particular a high level of safety against inhalation of dust, of an operator of a hand-held power tool on which the dust collection device according to the invention is arranged, in particular because it is advantageously possible to monitor an arrangement of the dust collection device on the hand-held power tool. Advantageously, a possibility can be created for informing an operator, in particular automatically, that the dust collection device is incorrectly arranged on the hand-held power tool.

It is furthermore proposed that the removable dust collection device comprise at least one sensing unit, which has at least one movement sensor for sensing at least one movement characteristic, in particular a vibration, of the basic structure, wherein the at least one sensed movement characteristic can be transmitted to the at least one external unit by means of the communication unit. A “sensing unit” is to be understood to mean, in particular, a unit that is designed to pick up at least one characteristic and/or a physical property, the pick-up being able to be effected actively, such as, in particular, by the generation and emission of an electrical measuring signal, and/or passively, such as, in particular, by sensing of changes in characteristics of a sensor component. Various sensing units, considered appropriate by persons skilled in the art, are conceivable. The movement sensor is preferably realized as an acceleration sensor, in particular a multi-axis acceleration sensor. It is also conceivable, however, for the movement sensor to be of a different design, considered appropriate by persons skilled in the art, such as, for example, designed as a vibration sensor such as, for example, a piezoelectric vibration sensor or the like, an inclination and vibration sensor, an oscillation sensor or the like. The sensing unit is preferably connected by means of signal lines to the communication unit of the dust collection device for the purpose of exchanging, in particular electronic, data. It is conceivable for the sensing unit to be directly connected to the communication unit, or indirectly connected via an open-loop and/or closed-loop control unit of the dust collection device. An “open-loop and/or closed-loop control unit” is to be understood to mean, in particular, a unit having at least one set of control electronics. A “set of control electronics” is to be understood to mean, in particular, a unit having a processor unit and having a storage unit, and having an operating program stored in the storage unit. Preferably, the movement sensor is designed to sense movements of the dust collection device. Preferably, the movement sensor is designed to sense vibrations transmitted from the hand-held power tool, during operation of the hand-held power tool, to the dust collection device, in particular at least to the basic structure. Alternatively or additionally, it is conceivable for the movement sensor to be designed to sense movements of the dust collection device, in particular of the basic structure, in space.

The design according to the invention makes it possible for movement data that can be transmitted to the external unit to be sensed by simple constructional means. It becomes possible, advantageously, for movement data useful for safe operation of the hand-held power tool to be transmitted between the dust collection device and the external unit. In particular, transmission of movement data advantageously makes it possible to monitor correct arrangement of the dust collection device on the hand-held power tool.

It is further proposed that the removable dust collection device comprise at least one sensing unit, in particular the aforementioned sensing unit, which has at least one movement sensor for sensing at least one movement characteristic, in particular a vibration, of the basic structure, wherein the communication unit and the sensing unit are arranged at least in proximity to the connection nozzle, in particular in proximity to an inlet opening of the connection nozzle, of the basic structure. “Proximity” is to be understood to mean, in particular, a region having has a maximum distance relative to other elements, units and/or further regions, in particular elements, units and/or further regions arranged in the immediate vicinity, that in particular is less than 20 cm, preferably less than 15 cm, particularly preferably less than 10 cm, and very particularly preferably less than 5 cm. Preferably, the sensing unit, in particular the movement sensor, is arranged on an outer side of the connection nozzle. Alternatively or additionally, however, it is also conceivable for the sensing unit, in particular at least one sensor of the sensing unit, to be arranged at another position of the basic structure that is considered appropriate by persons skilled in the art.

The design according to the invention advantageously makes it possible, in particular when the dust collection device has been arranged on the hand-held power tool, to reliably sense movements of the dust collection device, in particular movements caused by operation of the hand-held power tool and acting upon the dust collection device. It becomes possible for movement data that can be transmitted to the external unit to be sensed by simple constructional means. It becomes possible, advantageously, for movement data for safe operation of the hand-held power tool to be transmitted between the dust collection device and the external unit.

It is additionally proposed that the removable dust collection device comprise at least one sensing unit, in particular the aforementioned sensing unit, which has at least one fluid-stream sensor, for sensing at least one fluid characteristic, which, for the purpose of sensing a stream of fluid flowing through the connection nozzle, is arranged on the connection nozzle of the basic structure, wherein the at least one sensed fluid characteristic can be transmitted to the at least one external unit by means of the communication unit. Preferably, the at least one fluid-stream sensor is arranged on the connection nozzle in such a manner that a stream of fluid flowing through the connection nozzle, in particular a stream of exhaust air generated by the hand-held power tool and flowing through the connection nozzle, at least when the dust collection device has been arranged on the hand-held power tool, can be sensed by means of the fluid-stream sensor. Preferably, the at least one fluid-stream sensor projects at least partially into a guide channel delimited by the connection nozzle. It is also conceivable, however, for the at least one fluid-stream sensor to project at least partially into a bypass arranged on the connection nozzle, or to be arranged in this bypass, or for the lat least one fluid-stream sensor to be arranged entirely in the guide channel delimited by the connection nozzle. Also conceivable are other arrangements, considered appropriate by persons skilled in the art, of the at least one fluid-stream sensor for sensing a stream of fluid flowing through the connection nozzle. The design according to the invention advantageously makes it possible for flow data that can be transmitted to the external unit to be sensed by simple constructional means. It becomes possible, advantageously, for flow data useful for safe operation of the hand-held power tool to be transmitted between the dust collection device and the external unit. In particular, as a result of transmission of flow data, it becomes possible, advantageously, to monitor correct arrangement of the dust collection device on the hand-held power tool.

It is furthermore proposed that the removable dust collection device comprise at least one module housing, in particular arranged in a removable manner on the basic structure, and at least one sensing unit, in particular the aforementioned sensing unit, which together with the communication unit is arranged in the module housing arranged on the basic structure. Preferably, the dust collection device comprises at least one energy storage unit for supplying energy to electrical and/or electronic components of the dust collection device, in particular at least the communication unit and/or the sensing unit. The energy storage unit is preferably realized as a battery. Alternatively or additionally, the dust collection device comprises at least one energy conversion unit, in particular an energy harvesting unit, by means of which mechanical movements and/or light can be converted into electrical energy. Preferably, the energy conversion unit is conductively connected to the energy storage unit, in particular for the purpose of storing converted energy. Alternatively or additionally, however, it is also conceivable that the dust collection device can be supplied with electrical energy as a result of being connected, in particular contactlessly or in a contacted manner, to the hand-held power tool. Preferably, the energy storage unit is arranged on, in particular in, the module housing, in particular arranged in a replaceable manner on the module housing. Preferably, the module housing can be arranged on the basic structure, in particular at the connection nozzle. It is also conceivable, however, that the module housing can be arranged at another position, considered appropriate by persons skilled in the art. Preferably, the d′ comprising at least one fixing unit by means of which the module housing can be arranged in a removable manner on the basic structure. The fixing unit is preferably designed for non-positive and/or positive and/or magnetic connection to the module housing. The fixing unit may comprise, for example, at least one latching element, bayonet closure, magnet, or other fixing elements or fixing structures considered appropriate by persons skilled in the art, for fixing the module housing to the basic structure. Alternatively, it is also conceivable for the module housing to be realized in particular at least partially integrally with the basic structure, in particular the connection nozzle. The design according to the invention advantageously enables the sensing unit and the communication unit to be arranged securely on the basic structure. Advantageously, a flexible arrangement of the module housing on the basic structure can be achieved. Advantageously, a modular structure can be realized, in particular for the purpose of retrofitting individual components, and also for retrofitting known dust collection devices realized without a communication unit and a sensing unit. It becomes possible for data that can be transmitted to the external unit to be sensed in an advantageously constructionally simple manner. Advantageously, it becomes possible for data useful for safe operation of the hand-held power tool to be transmitted between the dust collection device and the external unit.

Also proposed is a system comprising at least one removable dust collection device according to the invention, and comprising at least one hand-held power tool on which the dust collection device can be arranged in a removable manner, wherein the hand-held power tool has at least one, in particular wireless, communication unit. Preferably the, in particular wireless, communication unit of the hand-held power tool is of an analog design, in particular in respect of a communication standard, for in particular wireless, communication unit of the dust collection device. The communication unit of the hand-held power tool is preferably realized as a wireless communication unit. The communication unit of the hand-held power tool may be realized as a WLAN communication unit, a Bluetooth communication unit, a radio communication unit, an RF1D communication unit, an NFC unit, an infrared communication unit, a mobile network communication unit or the like. Particularly preferably, the communication unit of the hand-held power tool is designed for bidirectional data transmission. Alternatively or additionally, the communication unit of the hand-held power tool is realized as a wired communication unit such as, for example, a LAN communication unit, a USB communication unit or the like.

A “hand-held power tool” is to be understood to mean, in particular, a power tool, for performing work on workpieces, that can be transported by an operator without the use of a transport machine. The portable power tool has, in particular, a mass of less than 40 kg, preferably less than 10 kg, and particularly preferably less than 5 kg. The hand-held power tool may be realized as a circular saw, a compass saw, a power planer, a router, a power sander, a power drill, a hammer drill and/or chipping hammer, a window cutter, or other hand-held power tool considered appropriate by persons skilled in the art. Preferably, the hand-held power tool comprises at least one exhaust nozzle by means of which dust, in particular dust caused by work performed on a workpiece, such as, for example, dust resulting from removal of material from a workpiece, can be removed from a region of a working tool arranged on a tool receiver of the hand-held power tool, in a manner already known to persons skilled in the art.

Preferably, a start-up of the hand-held power tool may be identified by an actuation of a switch of the hand-held power tool, a flow of current, a rotation of an electric motor unit of the hand-held power tool, a sensing of vibrations of the hand-held power tool. In particular, the vibrations of the hand-held power tool are transmitted to devices/units/elements connected to the hand-held power tool such as, for example, the dust collection device connected to the hand-held power tool.

In particular, the sensing unit of the dust collection device may sense these transmitted vibrations. Preferably, sensed vibrations may be transmitted to the external unit, in particular to the hand-held power tool or the mobile communication device, in particular a smartphone, by means of the communication unit of the dust collection device. It is conceivable that an electronics unit of the external unit, in particular of the hand-held power tool and/or of the mobile communication device, evaluates the vibrations sensed by means of the sensing unit of the dust collection device in order to compare whether the dust collection device vibrates in a similar manner to the hand-held power tool. Preferably, an open-loop control or closed-loop control of the electric motor unit of the hand-held power tool is dependent on a comparison of the vibrations of the hand-held power tool and the vibrations of the dust collection device. If it is identified, for example, that the dust collection device is subject to vibrations similar to those of the hand-held power tool, it may preferably be identified that the dust collection device is arranged on the hand-held power tool. Preferably, operation of the hand-held power tool may continue. If it is identified, for example, that the dust collection device is not subject to any vibrations or is subject to vibrations that are different from those of the hand-held power tool, it may preferably be identified that the dust collection device is decoupled from the hand-held power tool. Preferably, operation of the hand-held power tool may be interrupted. For example, it is also conceivable that a start-up of the hand-held power tool is prevented in dependence on a deviation from a limit value of compared data, or that a number of start-ups of the hand-held power tool is limited if data from the dust collection device are not available. For example, it is conceivable that, following a start-up of the hand-held power tool and non-availability of data from the dust collection device, a number of further start-ups of the hand-held power tool is limited to, in particular, fewer than 30, preferably to fewer than eight, and particularly preferably to fewer than three start-ups. A limitation of a number of start-ups of the hand-held power tool may, for example, be reset or cancelled by an expiry of an internal timer, or reset or cancelled by an administrator. For example, it is conceivable that a limitation of a number of start-ups of the hand-held power tool is reset or cancelled following a timer expiry of twelve hours or the like. Preferably, the hand-held power tool or the mobile communication device comprises at least one optical, acoustic and/or haptic output unit such as, for example, a display, a loudspeaker, a vibration unit or the like that is designed to output information to an operator in dependence on the transmitted, in particular electronic, data. For example, it is conceivable that an operator can be made aware, by means of the output unit, that the dust collection device is not arranged on the hand-held power tool. Furthermore, the hand-held power tool or the mobile communication device preferably comprises at least one input unit for inputting operator commands. The input unit may be realized integrally with the output unit, in particular if the input unit is realized as a touch-sensitive display or the like. By means of the input unit, for example, an operator may be given the option of operating the hand-held power tool for a certain time via an over-write function in the event of an absence of data transmission or in the event of a discrepancy of a data comparison. In particular, the over-write function is stored or storable in a device memory of the hand-held power tool or in a database, and may be linked to and/or compared with further data such as, for example, an operator ID, a date, a time, a location, in which case enabling may be effected in dependence on a combination of the above-mentioned data. The over-write function may be linked to certain authorizations, such that only certain operators can call up this function.

Furthermore, it is also conceivable that the sensing unit of the dust collection device can be used to sense a fill quantity or an emptying of the collection bag or of the collection volume, such as, for example, by sensing a weight of the collection bag or of the collection volume, by sensing an opening of a closure element of the basic structure or the like. For sensing a fill quantity or an emptying, the sensing unit preferably comprises further sensors such as, for example, a magnetic sensor arranged on the lid, an NFC sensor or the like. Preferably, it is possible to estimate, in conjunction with a runtime measurement of the hand-held power tool and a definition of a type of the hand-held power tool as well as, in particular, operating information of the hand-held power tool, when a maximum fill quantity of the collection bag or of the collection volume has been attained, or when emptying of the collection bag or of the collection volume should be effected. Preferably, an operator can be informed, by means of the output unit, about the imminent attainment of a maximum fill quantity of the collection bag or the collection volume or an imminent emptying.

It can preferably be checked, by means of an evaluation of data sensed by means of the sensing unit of the dust collection device and of data of the hand-held power tool, whether the hand-held power tool and the dust collection device are subject the same movements over a certain time range. It may be checked, for example, whether the hand-held power tool and the dust collection device are moved together, in particular are subject to the same movement forces, even upon the hand-held power tool being “grasped”, in particular before the hand-held power tool is put into operation. If it can be identified, for example, that the hand-held power tool and the dust collection device are subject different movement forces, for example upon the hand-held power tool being “grasped”, the hand-held power tool can be prevented from being put into operation, in particular until the dust collection device is correctly arranged on the hand-held power tool and, in particular, the hand-held power tool and the dust collection device are moved together, preferably being subject to the same movement forces. It is conceivable that the hand-held power tool should be shaken together with the dust collection device after the dust collection device has been arranged on the hand-held power tool, in order to demonstrate that the hand-held power tool is moved together with the dust collection device, or a balancing of sensors of the hand-held power tool and of the dust collection device can be effected.

The design according to the invention advantageously enables data useful for safe operation of the hand-held power tool to be transmitted between the dust collection device and the external unit. In particular, transmission of data advantageously makes it possible to monitor correct arrangement of the dust collection device on the hand-held power tool. It is advantageously possible to achieve a high level of safety, in particular a high level of safety against inhalation of dust, of an operator of a hand-held power tool on which the dust collection device according to the invention is arranged, in particular because it is advantageously possible to monitor an arrangement of the dust collection device on the hand-held power tool. Advantageously, a possibility can be created for informing an operator, in particular automatically, that the dust collection device is incorrectly arranged on the hand-held power tool. Advantageously, a constructionally simply designed can be realized to enable a high level of operator safety.

The invention is additionally based on a method for operating a system according to the invention. It is proposed that, in at least one method step, an operational readiness of the hand-held power tool or an operation of the hand-held power tool be controlled, by open-loop or closed-loop control, in dependence on an exchange of data between the removable dust collection device and the hand-held power tool. The features already disclosed in relation to the dust collection device and the system can be applied analogously to the method. The design according to the invention advantageously enables data useful for safe operation of the hand-held power tool to be transmitted between the dust collection device and the external unit. In particular, transmission of data advantageously makes it possible to monitor correct arrangement of the dust collection device on the hand-held power tool. It is advantageously possible to achieve a high level of safety, in particular a high level of safety against inhalation of dust, of an operator of a hand-held power tool on which the dust collection device according to the invention is arranged, in particular because it is advantageously possible to monitor an arrangement of the dust collection device on the hand-held power tool.

It is further proposed that, in at least one method step, a balancing of at least one movement characteristic, in particular a vibration, of the hand-held power tool with at least one movement characteristic, in particular a vibration, of the removable dust collection device is performed, in particular for the purpose of enabling the operational readiness of the hand-held power tool or for controlling the operation of the hand-held power tool by open-loop or closed-loop control. By means of the design according to the invention it can advantageously be ensured that a dust collection device according to the invention is used correctly on the hand-held power tool. It is advantageously possible to achieve a high level of safety, in particular a high level of safety against inhalation of dust, of an operator of a hand-held power tool on which the dust collection device according to the invention is arranged, in particular because it is advantageously possible to monitor an arrangement of the dust collection device on the hand-held power tool.

It is additionally proposed that, in at least one method step, at least one filter characteristic of a filter unit of the dust collection device, in particular an air stream through the filter unit, be evaluated, in particular for the purpose of enabling the operational readiness of the hand-held power tool or for controlling the operation of the hand-held power tool by open-loop or closed-loop control. By means of the design according to the invention it can advantageously be ensured that a dust collection device according to the invention is used correctly on the hand-held power tool. Advantageously, an extraction efficiency of the hand-held power tool can be monitored.

It is furthermore proposed that, in at least one method step, a time characteristic be evaluated for the purpose of enabling the operational readiness of the hand-held power tool or for controlling the operation of the hand-held power tool by open-loop or closed-loop control. Preferably, a time characteristic is evaluated for the purpose of enabling an operational readiness of the hand-held power tool or for controlling an operation of the hand-held power tool by open-loop or closed-loop control. For example, it is conceivable for an evaluation, in particular a comparison of data from the hand-held power tool with data from the sensing unit of the dust collection device, to be effected, in particular by means of the external unit, within a time window of less than 30 s, in particular less than 10 s, and particularly preferably less than 5 s after the hand-held power tool has been started up. By means of the design according to the invention it can advantageously be ensured that a dust collection device according to the invention is used correctly on the hand-held power tool. It is advantageously possible to achieve a high level of safety, in particular a high level of safety against inhalation of dust, of an operator of a hand-held power tool on which the dust collection device according to the invention is arranged, in particular because it is advantageously possible to monitor an arrangement of the dust collection device on the hand-held power tool.

The dust collection device according to the invention, the system according to the invention and/or the method according to the invention are/is not intended in this case to be limited to the application and embodiment described above. In particular, the dust collection device according to the invention, the system according to the invention and/or the method according to the invention may have individual elements, component parts and units, and method steps, that differ in number from a number stated herein, in order to fulfill an operating principle described herein. Moreover, in the case of the value ranges specified in this disclosure, values lying within the stated limits are also to be deemed as disclosed and applicable in any manner.

### DRAWING

Further advantages are disclosed by the following description of the drawing. The drawing shows an exemplary embodiment of the invention. The drawings, the description and the claims contain numerous features in combination. Persons skilled in the art will also expediently consider the features individually and combine them to create appropriate further combinations.

There are shown:

FIG. 1 a removable dust collection device according to the invention, in a schematic representation,

FIG. 2 a sectional view of a module housing of the removable dust collection device according to the invention, in a schematic representation,

FIG. 3 a system according to the invention comprising the removable dust collection device according to the invention, in a schematic representation, and

FIG. 4 a schematic flow diagram of a method according to the invention for operation of the system according to the invention.

### Description of the Exemplary Embodiment

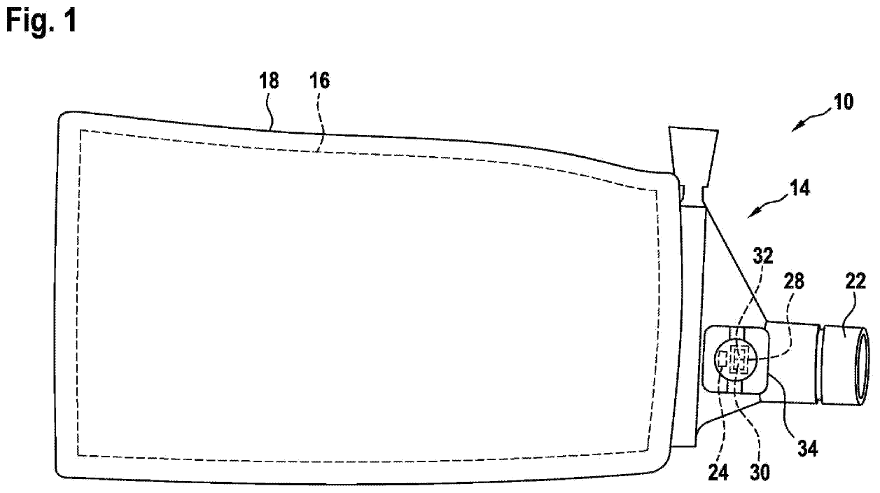

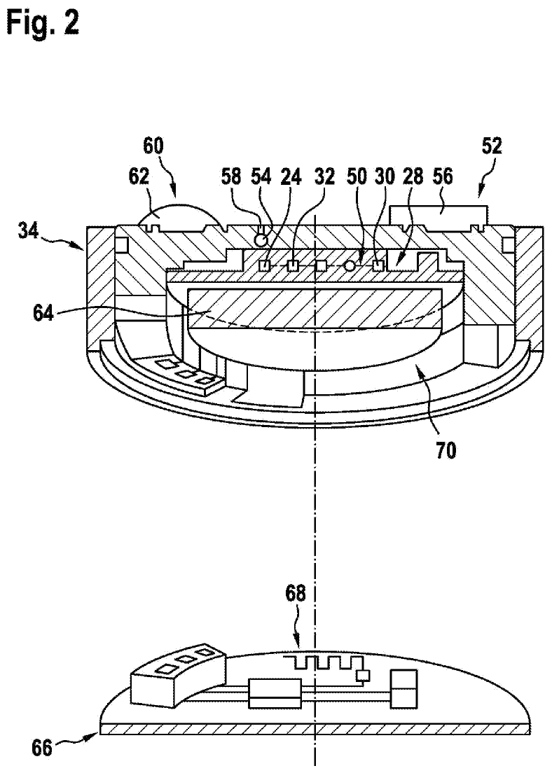

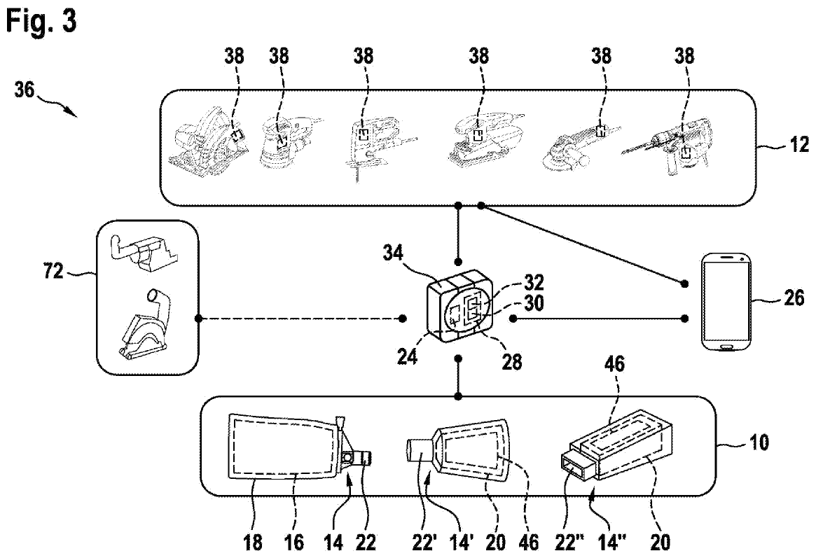

FIG. 1 shows a removable dust collection device 10, in particular a removable dust collection container, for a hand-held power tool 12 (cf. FIG. 3), comprising at least one basic structure 14, which has at least one frame 16 for receiving a variable-shape collection bag 18 or itself at least partially delimits a collection volume (cf. basic structure 14′,14″ in FIG. 3), the basic structure 14 having at least one connection nozzle 22 (cf. connection nozzle 22′,22″ in FIG. 3) for connection to an exhaust connection (not represented in greater detail here) of the hand-held power tool 12, by means of which nozzles the basic structure 14 can be arranged in a removable manner on the hand-held power tool 12, in particular in a manner known to a skilled person. Preferably, in at least one design of the dust collection device 10, the dust collection device 10 comprises at least one filter unit 46 (cf. FIG. 3). The dust collection device 10 comprises at least one, in particular wireless, communication unit 24 (cf. also FIG. 2) for exchanging, in particular electronic, data with at least one external unit, in particular the hand-held power tool 12 or a mobile communication device 26 (cf. FIG. 3). For example, the mobile communication device 26 is a smartphone. It is also conceivable, however, for the mobile communication device 26 to be of another design, considered appropriate by persons skilled in the art, such as, for example, as a tablet, a PDA or the like.

The dust collection device 10 comprises at least one sensing unit 28 (cf. FIG. 2), which has at least one movement sensor 30 for sensing at least one movement characteristic, in particular a vibration, of the basic structure 14, wherein the at least one sensed movement characteristic can be transmitted to the at least one external unit by means of the communication unit 24. The at least one sensing unit 28 preferably comprises the at least one movement sensor 30 for sensing at least one movement characteristic, in particular a vibration, of the basic structure 14, the communication unit 24 and the sensing unit 28 being arranged in proximity to the connection nozzle 22 of the basic structure 14. The at least one sensing unit 28 preferably comprises at least one fluid-stream sensor 32, for sensing at least one fluid characteristic, which, for the purpose of sensing a stream of fluid flowing through the connection nozzle 22, is arranged on the connection nozzle 22 of the basic structure 14, wherein the at least one sensed fluid characteristic can be transmitted to the at least one external unit by means of the communication unit 24.

The dust collection device 10 preferably comprises at least one module housing 34, in particular arranged in a removable manner on the basic structure 14 (cf. also FIG. 2), and at least the sensing unit 28, which is arranged together with the communication unit 24 in the module housing 34 arranged on the basic structure 14.

FIG. 2 shows a section through the module housing 34. The dust collection device 10 preferably comprises an electronics unit 50 which forms an open-loop and/or closed-loop control unit of the dust collection device 10.

The electronics unit 50 preferably comprises an output unit 52. The output unit 52 comprises in particular at least output elements 54, 56 realized as light-emitting diodes. It is also conceivable, however, that the output unit 52 alternatively or additionally has at least one output element that is realized as a display, a loudspeaker, a mini-display or the like. Light information from the output element 54 is preferably guided to a surface of the module housing 34 via a light guide 58 of the output unit 52.

The electronics unit 50 preferably comprises an input unit 60. Preferably, the sensing unit 28 is at least partially integrated into the electronics unit 50. The input unit 60 preferably comprises an operating element 62 realized as an operating button or switch. It is also conceivable, however, that the input unit 60 alternatively or additionally has at least one operating element realized as a touch-sensitive or proximity-sensitive operating element, LED pushbutton, foils or the like.

The dust collection device 10 preferably comprises an energy storage unit 64 for supplying energy to electrical and/or electronic components of the dust collection device 10. The energy storage unit 64 is preferably arranged in the module housing 34. The energy storage unit 64 is preferably realized as a rechargeable battery. Preferably the, in particular wireless, communication unit 24 for wireless data exchange with an external unit, in particular with the hand-held power tool 12, is arranged in the module housing 34.

It is conceivable for the module housing 34 to comprise a receiving region 70 for receiving an expansion unit 66 of the dust collection device 10. The extension unit 66 preferably comprises a further electronics unit 68. It is also conceivable for the extension unit 66 to comprise an energy storage device. The expansion unit 66 is preferably designed to be coupled to the electronics unit 50. The expansion unit 66 is provided for a functional expansion of the electronics unit 50.

The module housing 34 is preferably detachably connected to the basic structure 14. Alternatively, it is conceivable for the module housing 34 to be realized integrally with the basic structure 14 and/or to be non-detachably connected to the basic structure 14.

FIG. 3 shows a system 36 comprising at least the removable dust collection device 10, and comprising at least one hand-held power tool 12 on which the dust collection device 10 can be arranged in a removable manner, wherein the hand-held power tool 12 has at least one, in particular wireless, communication unit 38. FIG. 3 shows various embodiment of a hand-held power tool 12 on which the dust collection device 10 can be arranged in a removable manner. Also represented in FIG. 3 are dust collection devices 10 that are realized differently in respect of a design of the basic structure 14, 14′,14″. Also represented is the mobile communication device 26, realized as a smartphone. The module housing 34 may alternatively be arranged on additional modules 72 of the system 36 by means of a fixing unit considered appropriate by persons skilled in the art. The additional modules 72 may be realized, for example, as protective hoods, as suction devices having their own drive unit or the like. Preferably, data that can be sensed by means of the sensing unit 28 of the dust collection device 10 can be processed by means of the hand-held power tool 12 and by means of the mobile communication device 26, in particular for the purpose of controlling an operation of the hand-held power tool 12 by open-loop or closed-loop control.

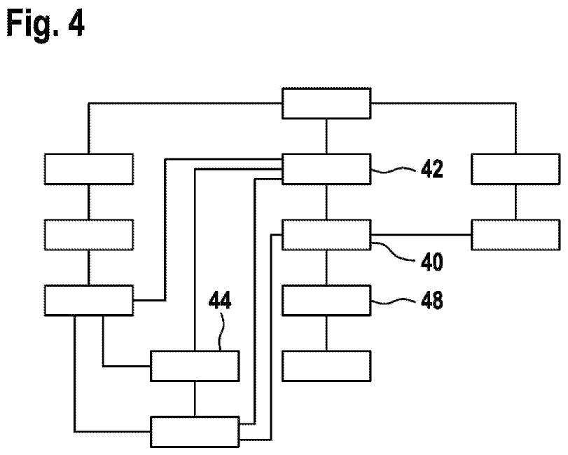

FIG. 4 shows a schematic flow diagram of a method for operating the system 36. In at least one method step 40, an operational readiness of the hand-held power tool 12 or an operation of the hand-held power tool 12 is controlled, by open-loop or closed-loop control, in dependence on an exchange of data between the removable dust collection device 10 and the hand-held power tool 12.

In at least one method step 42, a balancing of at least one movement characteristic, in particular a vibration, of the hand-held power tool 12 with at least one movement characteristic, in particular a vibration, of the removable dust collection device 10 is performed, in particular for the purpose of enabling the operational readiness of the hand-held power tool 12 or for controlling the operation of the hand-held power tool 12 by open-loop or closed-loop control. In at least one method step 44, at least one filter characteristic of a filter unit 46 of the dust collection device 10, in particular an air stream through the filter unit 46, is evaluated, in particular for the purpose of enabling the operational readiness of the hand-held power tool 12 or for controlling the operation of the hand-held power tool 12 by open-loop or closed-loop control. In at least one method step 48, a time characteristic is evaluated for the purpose of enabling the operational readiness of the hand-held power tool 12 or for controlling the operation of the hand-held power tool 12 by open-loop or closed-loop control.

Preferably, a start-up of the hand-held power tool 12 may be identified by an actuation of a switch (not represented in greater detail) of the hand-held power tool 12, a flow of current, a rotation of an electric motor unit (not represented in greater detail) of the hand-held power tool 12, a sensing of vibrations of the hand-held power tool 12. In particular, the vibrations of the hand-held power tool 12 are transmitted to devices/units/elements connected to the hand-held power tool 12 such as, for example, the dust collection device connected to the hand-held power tool 12. In particular, the sensing unit 28 of the dust collection device 10 may sense these transmitted vibrations. Preferably, sensed vibrations may be transmitted to the external unit, in particular to the hand-held power tool 12 or the mobile communication device 26, in particular a smartphone, by means of the communication unit 24 of the dust collection device 10. It is conceivable that an electronics unit of the external unit, in particular of the hand-held power tool 12 and/or of the mobile communication device 26, evaluates the vibrations sensed by means of the sensing unit 28 of the dust collection device 10 in order to compare whether the dust collection device 10 vibrates in a similar manner to the hand-held power tool 12. Preferably, an open-loop control or closed-loop control of the electric motor unit of the hand-held power tool is dependent on a comparison of the vibrations of the hand-held power tool 12 and the vibrations of the dust collection device 10. If it is identified, for example, that the dust collection device 10 is subject to vibrations similar to those of the hand-held power tool 12, it may preferably be identified that the dust collection device 10 is arranged on the hand-held power tool 12. Preferably, operation of the hand-held power tool 12 may continue. If it is identified, for example, that the dust collection device 10 is not subject to any vibrations or is subject to vibrations that are different from those of the hand-held power tool 12, it may preferably be identified that the dust collection device 10 is decoupled from the hand-held power tool 12. Preferably, operation of the hand-held power tool 12 may be interrupted. For example, it is also conceivable that a start-up of the hand-held power tool 12 is prevented in dependence on a deviation from a limit value of compared data, or that a number of start-ups of the hand-held power tool 12 is limited if data from the dust collection device 10 are not available. For example, it is conceivable that a limitation of a number of start-ups of the hand-held power tool 12 is reset or cancelled following a timer expiry of twelve hours or the like. Preferably, the hand-held power tool 12 or the mobile communication device 26 comprises at least one optical, acoustic and/or haptic output unit (not represented in greater detail here) such as, for example, a display, a loudspeaker, a vibration unit or the like that is designed to output information to an operator in dependence on the transmitted, in particular electronic, data. For example, it is conceivable that an operator can be made aware, by means of the output unit, that the dust collection device 10 is not arranged on the hand-held power tool 12. Furthermore, the hand-held power tool 12 or the mobile communication device 26 preferably comprises at least one input unit (not represented in greater detail here) for inputting operator commands. The input unit may be realized integrally with the output unit, in particular if the input unit is realized as a touch-sensitive display or the like. By means of the input unit, for example, an operator may be given the option of operating the hand-held power tool 12 for a certain time via an over-write function in the event of an absence of data transmission or in the event of a discrepancy of a data comparison. In particular, the over-write function is stored or storable in a device memory (not represented in greater detail here) of the hand-held power tool 12 or in a database, and may be linked to and/or compared with further data such as, for example, an operator ID, a date, a time, a location, in which case enabling may be effected in dependence on a combination of the above-mentioned data. The over-write function may be linked to certain authorizations, such that only certain operators can call up this function.

Furthermore, it is also conceivable that the sensing unit 28 of the dust collection device 10 can be used to sense a fill quantity or an emptying of the collection bag 18 or of the collection volume 20, such as, for example, by sensing a weight of the collection bag 18 or of the collection volume 20, by sensing an opening of a closure element (not represented in greater detail here) of the basic structure 14, 14′,14″ or the like. For sensing a fill quantity or an emptying, the sensing unit 28 preferably comprises further sensors (not represented in greater detail here) such as, for example, a magnetic sensor arranged on the lid, an NFC sensor or the like. Preferably, it is possible to estimate, in conjunction with a runtime measurement of the hand-held power tool 12 and a definition of a type of the hand-held power tool 12 as well as, in particular, operating information of the hand-held power tool 12, when a maximum fill quantity of the collection bag 18 or of the collection volume 20 has been attained, or when emptying of the collection bag 18 or of the collection volume 20 should be effected.

Preferably, an operator can be informed, by means of the output unit, about the imminent attainment of a maximum fill quantity of the collection bag 18 or the collection volume 20 or an imminent emptying.

It can preferably be checked, by means of an evaluation of data sensed by means of the sensing unit 28 of the dust collection device 10 and of data of the hand-held power tool 12, whether the hand-held power tool 12 and the dust collection device 10 are subject the same movements over a certain time range. It may be checked, for example, whether the hand-held power tool 12 and the dust collection device 10 are moved together, in particular are subject to the same movement forces, even upon the hand-held power tool being “grasped”, in particular before the hand-held power tool 12 is put into operation. If it can be identified, for example, that the hand-held power tool 12 and the dust collection device 10 are subject different movement forces, for example upon the hand-held power tool 12 being “grasped”, the hand-held power tool 12 can be prevented from being put into operation, in particular until the dust collection device 10 is correctly arranged on the hand-held power tool 12 and, in particular, the hand-held power tool 12 and the dust collection device 10 are moved together, preferably being subject to the same movement forces. It is conceivable that the hand-held power tool 12 should be shaken together with the dust collection device 10 after the dust collection device 10 has been arranged on the hand-held power tool 12, in order to demonstrate that the hand-held power tool 12 is moved together with the dust collection device 10, or a balancing of sensors of the hand-held power tool 12 and of the dust collection device 10 can be effected.

1. A removable dust collection device for a hand-held power tool, comprising:
a basic structure including at least one frame (i) configured to receive a variable-shape collection bag or (ii) configured to at least partially delimit a collection volume the basic structure further including at least one connection nozzle configured to connect to an exhaust nozzle of the hand-held power tool such that the basic structure is arranged in a removable manner on the hand-held power tool; and
at least one communication unit configured to exchange electronic data with at least one external unit.

2. The removable dust collection device as claimed in claim 1, further comprising:
at least one sensing unit including at least one movement sensor configured to sense at least one movement characteristic of the basic structure,
wherein the at least one communication unit is configured to transmit the at least one sensed movement characteristic to the at least one external unit.

3. The removable dust collection device as claimed in claim 1, further comprising:
at least one sensing unit including at least one movement sensor configured to sense at least one movement characteristic of the basic structure,
wherein the at least one communication unit and the at least one sensing unit are arranged at least in proximity to the at least one connection nozzle of the basic structure.

4. The removable dust collection device as claimed in claim 1, further comprising:
at least one sensing unit including at least one fluid-stream sensor configured to sense at least one fluid characteristic based on, a stream of fluid flowing through the at least one connection nozzle,
wherein the at least one fluid-stream sensor is arranged on the at least one connection nozzle of the basic structure, and
wherein the at least one communication unit is configured to transmit the at least one sensed fluid characteristic to the at least one external unit.

5. The removable dust collection device as claimed in claim 1, further comprising:
at least one module housing arranged in a removable manner on the basic structure; and
at least one sensing unit,
wherein the at least one sensing unit and the at least one communication unit are arranged in the at least one module housing arranged on the basic structure.

6. A system comprising:
at least one hand-held power tool including an exhaust nozzle and at least one communication unit and
at least one removable dust collection device operably connected to the at least one hand-held power tool, the at least one removable dust collection device including:
a basic structure including at least one frame (i) configured to receive a variable-shape collection bag or (ii) configured to at least partially delimit a collection volume, the basic structure further including at least one connection nozzle configured to connect to the exhaust nozzle; and
at least one further communication unit,
wherein the at least one removable dust collection device is arranged in a removable manner on the at least one hand-held power tool device,
wherein the at least one communication unit of the hand-held power tool is configured to exchange electronic data with the at least one further communication unit of the at least one removable dust collection device.

7. A method for operating a system, comprising:
controlling an operational readiness of a hand-held power tool or an operation of the hand-held power tool by open-loop or closed-loop control, in dependence on an exchange of electronic data between a removable dust collection device operably connected to the hand-held power tool and the hand-held power tool,
wherein the system includes:
the hand-held power tool including an exhaust nozzle and at least one communication unit; and
the removable dust collection device including:
a basic structure including at least one frame (i) configured to receive a variable-shape collection bag or (ii) configured to at least partially delimit a collection volume, the basic structure further including at least one connection nozzle configured to connect to the exhaust nozzle; and
at least one further communication unit,
wherein the removable dust collection device is arranged in a removable manner on the hand-held power tool device,
wherein at least one communication unit of the hand-held power tool is configured to exchange the electronic data with the at least one further communication unit of the at least one removable dust collection device.

8. The method as claimed in claim 7, further comprising:
balancing at least one movement characteristic of the hand-held power tool with at least one movement characteristic of the removable dust collection device to enable the operational readiness of the hand-held power tool or to control the operation of the hand-held power tool by open-loop or closed-loop control.

9. The method as claimed in claim 7 further comprising:
evaluating at least one filter characteristic of a filter unit of the dust collection device to enable the operational readiness of the hand-held power tool or to control the operation of the hand-held power tool by open-loop or closed-loop control.

10. The method as claimed in claim 7, further comprising:
evaluating a time characteristic to enable the operational readiness of the hand-held power tool or to control the operation of the hand-held power tool by open-loop or closed-loop control.

11. The removable dust collection device as claimed in claim 1, wherein the at least one external unit includes the hand-held power tool and/or a mobile communication device.

12. The method as claimed in claim 8, wherein:
the at least one movement characteristic of the hand-held power tool is a vibration, and
the at least one movement characteristic of the removable dust collection device is another vibration.
